(19) United States
(12) Patent Application Publication
(10) Pub. No.: US 2025/0301402 A1
(43) Pub. Date: Sep. 25, 2025

(54) OPTIMIZATION OF FUNCTIONALITY IN ACCESS POINT DEVICES BASED ON MACHINE LEARNING, INCLUDING OPTIMIZATION OF POWER CONTROL IN ACCESS POINT DEVICES

(71) Applicant: Arista Networks, Inc., Santa Clara, CA (US)

(72) Inventors: Shailendra Singh Suriyal, Srinagar Garhwal (IN); Venkatesh Ramachandran, Bengaluru (IN)

(21) Appl. No.: 18/610,043

(22) Filed: Mar. 19, 2024

(51) Int. Cl. H04W 52/02; G06N 20/00; H04W 52/22

(52) U.S. Cl. CPC H04W 52/0206; G06N 20/00; H04W 52/223

(57) ABSTRACT

Systems and methods for the proactive control and management of power usage of APs in a network are disclosed. Embodiments of such systems and methods can train a machine learning model for power control of APs in the network based on telemetry data from those APs. That machine learning model can be utilized to generate predictions associated with power control of the APs in the network such that those power control predictions can be used to determine power control directives associated with functionality of the APs.

### BACKGROUND

Enterprises that deploy Wi-Fi networks incur cost to operate those networks. These costs are not insignificant. The costs are, however, often far greater than is actually required to provide such wireless networks. To illustrate, the wireless networks may be designed to provide a certain level of service based on particular usage criteria. Typically this usage criteria will specify a maximum number of users. Thus, wireless networks are usually architected to provide adequate service in a worst case scenario (e.g., the maximum number of users are accessing the wireless network). These planned for worst case scenarios are, however, rarely encountered. As such, wireless networks are often operated at maximum potential, even when there is no need. The operation of a wireless network in this manner can incur substantial unneeded costs as the maximum potential of a fully operational network goes unutilized (and in fact may go unutilized the vast majority of the time).

It would thus be desirable to employ energy saving measures in association with the deployment of wireless networks to, for example, reduce the operational costs of those networks.

Conventional power saving strategies are, however, reactive. What is desired instead are automated and data-driven approaches for proactive control of the functionality of wireless networks to, for example, reduce power consumption in conjunction with the operation of those networks.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a block diagram depicting a general architecture of a network including one embodiment of a network management system.

FIG. 2 is a block diagram of an embodiment of entities in a managed network.

FIG. 3 is a flow diagram of one embodiment of a method of power control of APs in a network using machine learning.

### DETAILED DESCRIPTION

As discussed, enterprises that deploy Wi-Fi networks incur cost to operate these networks. These costs are not insignificant. The costs are, however, often far greater than is actually required to provide a desired quality of service with respect to these wireless networks. To illustrate in more detail, when wireless networks are designed it is typically the case that they are designed based on the physical environment in which these wireless networks will be implemented, along with usage criteria such as a maximum or minimum number of users that will be co-located on the network or particular portions or locations covered by that network. The wireless network can then be designed and implemented to include a number of appropriately located Wi-Fi APs (access points) to provide the desired level of service even under a worst case scenario.

These APs can be wireless communication devices that operate in accordance with the family of IEEE (Institute of Electrical and Electronics Engineers) 802.11 standards or 3GPP (3rd Generation Partnership Project) standards such as Long Term Evolution (LTE) and New Radio (NR). Clients (e.g., hosts or stations) can associate with APs in order to wirelessly communicate with other clients or hosts on the same network and to access other communication networks, such as the Internet.

While wireless networks are typically designed to accommodate a worst case scenario (e.g., to provide adequate service when an anticipated maximum number of clients are accessing the wireless network through APs, or when an anticipated maximum number of clients for each AP are coupled to those APs), it is often the case that the usage of the wireless networks (and usage of individual APs of the network) fall somewhere below (and in some cases far below) these planned for maximum usage scenarios. Moreover, the amount of time where the usage of these APs falls below the designed for maximum utilization may be far greater than the amount of time where the wireless network is used to its maximum potential.

For example, these types of wireless networks are often implemented in what is often referred to as a “campus” environment. A campus network can be thought of as a proprietary local area network (LAN) (or set of interconnected LANs) serving a university, corporation, government agency, or other organization or entity. Oftentimes in these sorts of network environments users desire to join, or access, the campus network, and do so through APs in the campus network. For example, users in a conference room or classroom may access a campus network through a wireless interface provided by APs in the network.

It is typically the case that usage of these types of campus networks falls far below any planned for maximum capacity during certain times (e.g., overnights, on holidays, during certain seasons such as summer, etc.). Additionally, there may be certain circumstances where low usage may persist for an extended period of time. For instance, during the COVID pandemic many people were working or other accessing networks remotely, but few if any people were physically accessing these networks wirelessly using the provided APs.

Nonetheless during these off-peak times, APs may still be operated in full-function mode (i.e., with all AP features running at their maximum potential). An AP operating in full function mode, running at its maximum potential, consumes maximum energy. The operation of APs in full function mode even when this full functionality is unwarranted (e.g., when usage of an AP is below some threshold such as off peak times) can thus incur substantial unneeded costs that must be borne by providers of these wireless networks.

To be more specific, in most cases, APs are always powered on (e.g., at full power) even when there are no users to associate with that AP. They are kept up in anticipation of any users that may connect or due to human intervention involved in tracking and powering these APs on or off as needed (e.g., on a substantially continuous basis). This situation leads to unnecessary energy wastage, extra electricity usage and cost to the providers of the network. Moreover, this problem is widespread, as it applies to any entity that does not have a continuous (e.g., maximum) flow of users on their wireless network.

Energy saving measures employed in association with these APs in the context of wireless networks can thus significantly reduce operating costs associated with providing such a network, while at the same time maintaining a desired quality of service to users accessing the network. Conventional power saving strategies are, however, reactive. Namely, the operation of APs may be controlled (e.g., manually) based on observed static data about a state of operation of the AP or wireless network such that the AP is controlled in response to such observed data. For example, a person can manually shut down APs (or the entire network) outside of business hours.

What is desired, then, are automated and data-driven approaches for proactive control of the functionality of APs in wireless networks to, for example, reduce power consumption of such APs.

To address those desires, among others, embodiments as disclosed herein may train and utilize one or more machine learning models for proactive control of APs in a network. Initially, a set of data may be determined for, where that set of data includes data on features related to the network and, in particular, APs on the network. In particular, an AP (or a management module thereon) may be configured to access a particular location (Uniform Resource Locator (URL)) associated with a network management module to send telemetry data from the AP to that URL on the network. This telemetry data can thus be sent and received at regular intervals (e.g., every 10 seconds, every minute, every hour, etc.) and stored in the network in association with that AP by the network management module.

This telemetry data may include timestamped data for the AP, on, for example, a number of active clients denoting a number of clients that are associated with the AP and are deemed “active.” In some embodiments, a client can be deemed active based on the number of data units (bytes, packets, etc.) exchanged during a period of time. The telemetry data may also include a number of connected clients per radio. As some APs can be configured with multiple radios; e.g., 2.4 GHZ radio, 5 GHz radio, etc., this data can refer to the number of clients that are active on a given radio. Data on each connected client can also be included in the telemetry data such as device identifiers, number of packets received or sent to the client, or other client specific information.

Other telemetry data may include buffer occupancy which may pertain to the average size of all the data queues at the AP used to buffer uplink and downlink packets. The telemetry data may include Ethernet link utilization associated with (e.g., average) values of the uplink and downlink utilization of a given Ethernet link or self-channel utilization associated with the utilization of a channel (transmit and receive activity) for a given period of time during which the radio occupied the channel to transmit and receive signals. Each radio in the AP may be associated with a self-channel utilization metric. Such telemetry data may also include configuration settings such as active (or inactive) features on the AP, as some protocol or software features utilized by the AP can result in increased consumption of power when enabled. Certain of the telemetry data may also include data on physical operating parameters pertaining to the AP such as temperature data.

Other data associated with the network (and APs within the network) may also be collected. Such data can include a static list of devices (e.g., Internet of Things (IOT) devices) that may be coupled to each AP and physical configurations of the APs such as the model numbers or information on types of antennae equipped on the AP. This type of data may be obtained, for example, from an inventory database or the like that may be created or maintained by designers or providers of the network. Environmental data may also be determined based on sensors deployed in the physical environment in which the network exists. This environmental data may include the physical layout (e.g., floorplans) of the environment in which the network is installed or the location of APs within that physical environment or other data on the physical environment in which the network operates such as movement data corresponding to the movement of users within the physical environment.

This data may be collected (e.g., at regular intervals) for an initial time period (e.g., a week, a month, etc.) The collected data on the APs in the network can then be cleansed and augmented. Data used to augment collected telemetry data may include data derived from a single data set from an AP or derived from data in two or more data sets received from the AP. Thus, derived data may be data that can be determined based on the data provided to the network management module by the APs (e.g., either the same or different APs). For example, the type of devices that are connected to the AP at a given time may be derived using device profiling based on the information about these devices (e.g., the IP or MAC address of the device) sent from the AP in telemetry data provided by that AP. The derived data may also include authentication or accounting data that may be determined from authentication, authorization, and accounting (AAA) servers such as those using the Remote Authentication Dial-In User Service (RADIUS) protocol. Derived data may also include determining devices which are constantly connected to an AP by comparing connected clients across data sets to determine which clients are substantially always connected to that AP and do not move or disconnect.

The cleansing of data may involve removing data points for a label (e.g., parameter or metric) that are outside a certain range of values for that parameter. For example, data points may be removed that are outside a standard deviation of the range of values for those points. In some embodiments, this cleansing may occur on each set of telemetry data provided by an AP and the range of values for a parameter that are used to determine standard deviations for cleansing of that data may be based on the range of values in that set of telemetry data as received from that AP. When a value for a parameter is discovered that is outside the range of values for that parameter it may be removed, or it may be set to a maximum high value or a minimum low value. Those maximum high values and minimum low values may also be determined based on the range of values for that parameter in that particular set of telemetry data as received from the AP.

Once the data for an AP is collected (e.g., and cleansed and augmented) this data may be utilized to train a machine learning model for prediction of power control. Machine learning techniques enable a machine to learn how to automatically, and accurately, make predictions based on historical observation. Training (and retraining) of a machine learning model is the process by which cleansed training data comprising a set of labeled data (e.g., the metrics or parameters included in the data) is converted into an executable model, or such a model is retrained. Training a machine learning model involves feeding a machine learning algorithm the determined training data. For example, training a machine learning model to classify data may involve training a machine learning algorithm with the training data to build one or more machine learning models for mapping an input space to labels in a discrete label set. In other words, a prediction or classification for a label can be generated based on a set of labeled input values.

There are many platforms, frameworks, and algorithms available for machine learning model training and inference. In certain embodiments, a machine learning model for classification using time-series data may be trained. There are various model training frameworks that can be used (e.g., TENSORFLOW by Google, PyTorch, and MXNet). Further there are many ML algorithms (e.g., K-Means, Logistic Regression, Support Vector Machines, Bayesian Algorithms, Perceptron, Convolutional Neural Networks, Recurrent Neural Networks such as Long Short-Term Memory, Random Forest, Isolation Forest) that may be employed according to embodiments.

In one embodiment, multiple machine learning models may be trained based on the cleansed training data. For example, there may be a trained machine learning model corresponding to each of the APs of the network, where that machine learning model was trained based on corresponding data obtained from, and associated with, that particular AP. Each of the trained models may be adapted to provide a prediction for one or more labels for the corresponding AP (e.g., values for a label of interest for that AP based on a set of values for one or more input labels). In one embodiment, for example, the trained model may be configured to provide a prediction for a label associated with a number of clients for the corresponding AP (or a binary value predicting whether any clients will be connected to that AP) based on, for example, a provided time or other provided input values for label data. Such a prediction may further comprise a number of clients that may be coupled to different radios (e.g., different frequency radios) of the AP during the time period when the AP is configured with multiple radios.

The trained machine learning model for an AP may then be evaluated. For example, when a machine learning model for power control of a corresponding AP is trained it may be evaluated for a period of time, where predictions (e.g., values for a label such as number of connected clients for a time or time period) generated by the trained machine learning model for an AP are evaluated against actual data sets obtained from that AP to determine a quality metric associated with the trained model for that AP. These actual data sets may be data sets from the AP that are different from the data sets obtained from the AP that were used to train that machine learning model. For example, the trained machine learning model for an AP may be used to generate predictions for a future time period for that AP and those predictions compared against actual data obtained from the AP after that future time period has passed. Quality metrics known in the art such as accuracy, precision or recall may be utilized to evaluate the trained machine learning model such that it can be determined when a desired efficacy of the trained machine learning model is achieved. If a desired threshold for the quality metric is not met the machine learning model may be additionally trained (e.g., on a different or additional set of training data). Once a desired threshold for the quality metric is met for the model (e.g., a 95 percent accuracy with respect to comparison of predicted values for a time period to actual values for that time period), it can be determined the machine learning model may be utilized for power control of the AP, otherwise additional training may be undertaken on the machine learning model.

In some embodiments, multiple (e.g., challenger) machine learning models for a particular corresponding AP may be trained and evaluated, where these trained machine learning models may be different types of machine learning models. These multiple trained challenger machine learning models for an AP can then be evaluated against each other (e.g., or a current active model for the AP) to determine which machine learning model (or models) trained for that AP should be selected as a current active model for generating predictions for that AP (e.g., responses to labeling requests). This evaluation can be based, for example, on a quality metric determined for each of the challenger machine learning models. The result of this evaluation may be a selected champion machine learning model that represents the best model currently producible given the available training data (e.g., as determined from a quality metric associated with each of the machine learning models). This champion machine learning model can thus be used as an active model for generating predictions (e.g., values for labels in response to labeling requests).

Moreover, embodiments may be configured to utilize one or more training triggers such that when a training trigger is detected, a (re) training of a machine learning model for an AP may be initiated. Training triggers may be based on, for example, an amount of training data received from an AP, quality metrics determined for an active machine learning model, elapsed time, or other criteria.

Once an active machine learning model is determined (e.g., a quality metric for a trained machine learning model is determined to be above some threshold or a best machine learning model is selected from a set of challenger machine learning models) that machine learning model can be utilized to generate predictions associated with power control of the corresponding AP in the network. In other words, values for certain labels may be generated using the active machine learning model for the AP, where those values are predictive of values for that label based on one or more input label values. These power control predictions may be generated based on certain time periods (e.g., seconds, hours, days, weeks, etc.) for future time periods (e.g., the time period may serve as a labeled input value). In one embodiment, for example, predictions may be generated for a number of clients that will be connected to the corresponding AP for a number of times or time periods.

The power control predictions generated by the machine learning model corresponding to the AP can then be used to determine a power control directive for the AP associated with certain functionality of the AP. This power control directive may be associated with a functionality of the AP and may specify a set of functionality or a power level associated with that functionality. For example, a predicted number of clients for a time period may be used to determine whether to power on or power off the AP or certain functionality during that time period. Accordingly, a binary decision can be made to power on or power off the AP or certain functionality of the AP based on if one or more clients are predicted to be connected to that AP during that time period. As another example, the predicted number of clients generated by the machine learning model for the time period may be used to determine a power level for certain functionality of the AP (e.g., high, medium, low, off) based on a threshold number of clients associated with each of these power levels.

Based on this determined power control directive for the AP, power control instructions may be determined and sent to the management module on the AP to control the AP during the corresponding time period. The management module on the AP can effectuate the power control instructions on the AP to change an operational state of the AP in accordance with power control directive. Such power control instructions can, for example, scale (e.g., reduce or turn off) certain functionality on the AP (e.g., power the AP down, provide fewer functions, less capacity, etc.). Alternatively, the power control directive (or predictions generated by the machine learning model) may be presented as a set of recommendations for the corresponding time period to a user (e.g., of network management). For example, the power control directive may be presented through a network management interface in association with an identifier for the AP and the time period corresponding to the power control directive.

Various operational aspects of the AP can be controlled to change the power consumed by the AP, whether to decrease power consumption or increase power consumption to resume full-function operation. This functionality can be controlled (e.g., functionality increased, decreased, turned ON, turned OFF, etc.) to change the power consumption of the AP in response to power control instructions. For example, one or more radios in the AP can be placed in the on or off state to reduce power consumption. Accordingly, if the AP is configured with multiple radios a power control instruction may be to turn off some but not all radios. Universal Serial Bus (USB) capabilities can also be placed in an on (enabled) or off (disabled state). The Bluetooth capability of an AP may also be placed in Bluetooth Low Energy mode. The TX or RX chains of the AP may also be controlled. To illustrate, each radio in an AP can have multiple (2, 4, 8, etc.) independent transmit/receive chains. The chains allows the AP to multiplex a signal across two or more chains, for example, to achieve higher throughput, to reduce errors, etc. These TX or RX chains on the AP can thus be adjusted to alter the power consumed by the radio on the AP (e.g., more chains require more power, fewer chains require less power). Similarly, transmit power for each radio of the AP can be adjusted to change the AP's power consumption while maintaining a desired level of coverage. In some embodiments, the power can be adjusted between a maximum transmit power level (Pmax) and a minimum transmit power (Pmin). Likewise, channel bandwidth of these radios may also be controlled. Specifically, the usage of different bandwidths affect power consumption of the AP differently—more bandwidth requires more power. Thus, the radios of an AP can be adjusted to transmit in narrower bandwidths to reduce power consumption. For instance, bandwidths to control can be selected from 320/160/80/40/20 MHz. Protocol or software functionality of the AP may also be controlled to reduce power consumption. Specifically, certain protocols or software features can impact how much power is consumed by the AP. These features can be disabled to reduce power consumption. For example, scanning of the RF environment is a feature that can be turned off to reduce power. Other features can be tuned or adjusted to reduce power, but otherwise remain enabled.

Embodiments as disclosed may thus have a number of advantages. Specifically, embodiments can allow proactive optimization of each individual AP within a network to reduce power usage of individual APs within the network without adversely impacting either the quality of service associated with that AP, or quality of service across the entire network. Moreover, such optimization can be continually refined and improved to account for differing conditions and changes in the network or its usage (e.g., by retraining the machine learning model for an AP based on newly obtained data). By providing such power control embodiments may also have the effect of increasing the lifespan of the controlled APs by reducing the load on the components (e.g., chipsets, radios, etc.) of these APs.

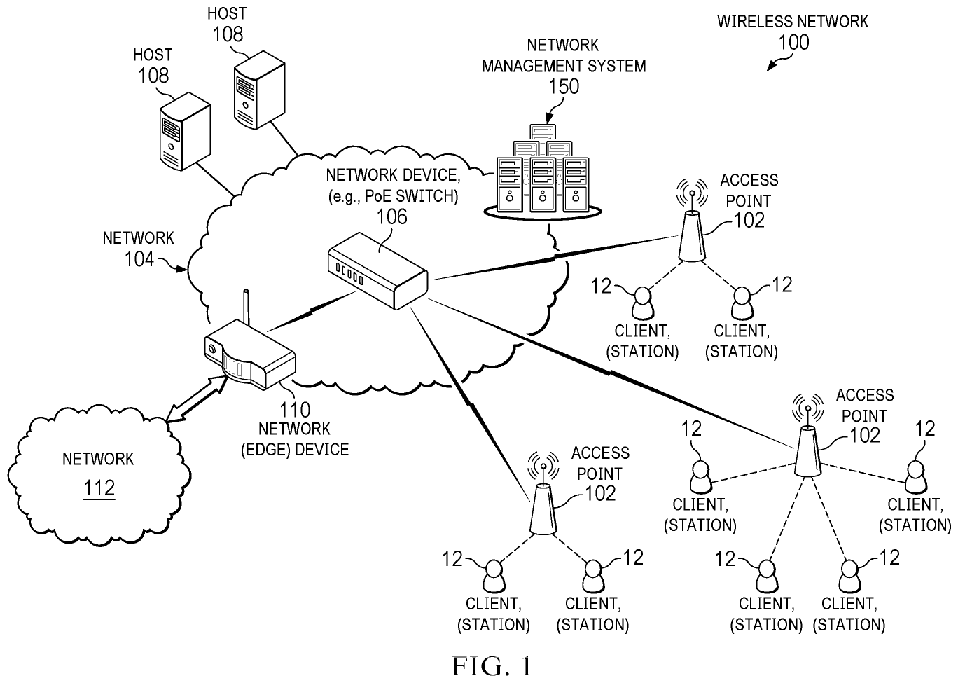

Turning now to FIG. 1, a block diagram depicting a general architecture of a network including one embodiment of a network management system is presented. Here, access points (AP) APs are deployed in a managed wireless network 100 (e.g., a Wi-Fi network which may be used herein in accordance with describing embodiments without loss of generality). Wireless network 100 can include APs 102 and host machines 108 (e.g., servers, desktop users, laptop users, etc.). Communication network 104 can comprise network devices 106 to which APs 102 and host machines 108 can be connected or otherwise be in communication with. Communication network 104 can further comprise one or more network devices 110 (also referred to as edge devices) to allow for communication between network devices 106 and other networks 112 such as a PSTN (public switched telephone network), other networks in an enterprise, the Internet, etc.

APs 102 can be wireless communication devices that operate in accordance with the family of IEEE 802.11 standards or 3GPP standards such as Long Term Evolution (LTE) and New Radio (NR). For discussion purposes, certain embodiments may be described with respect to technology of IEEE 802.11. However, it will be appreciated that embodiments may be applicable to other wireless technologies and all such embodiments are contemplated. Clients (stations) 12 can associate with APs 102 in order to wirelessly communicate with other clients on the same or different AP, with host machines 108 on network 104, with communication network 112, or with other entities.

Managed wireless network 100 may also include network management system 150. Network management system may include one or more applications or computing devices adapted to control the power of APs 102 within the network or provide power control data (e.g., recommendations associated with APs 102 to users of network management system 150. These power control instructions or power control data may be based on power control directives determined at the network management system 150 using machine learning generated predictions for such power control generated by the network management system 150 using machine learning models associated with the APs 102 and trained using data obtained from those APs 102.

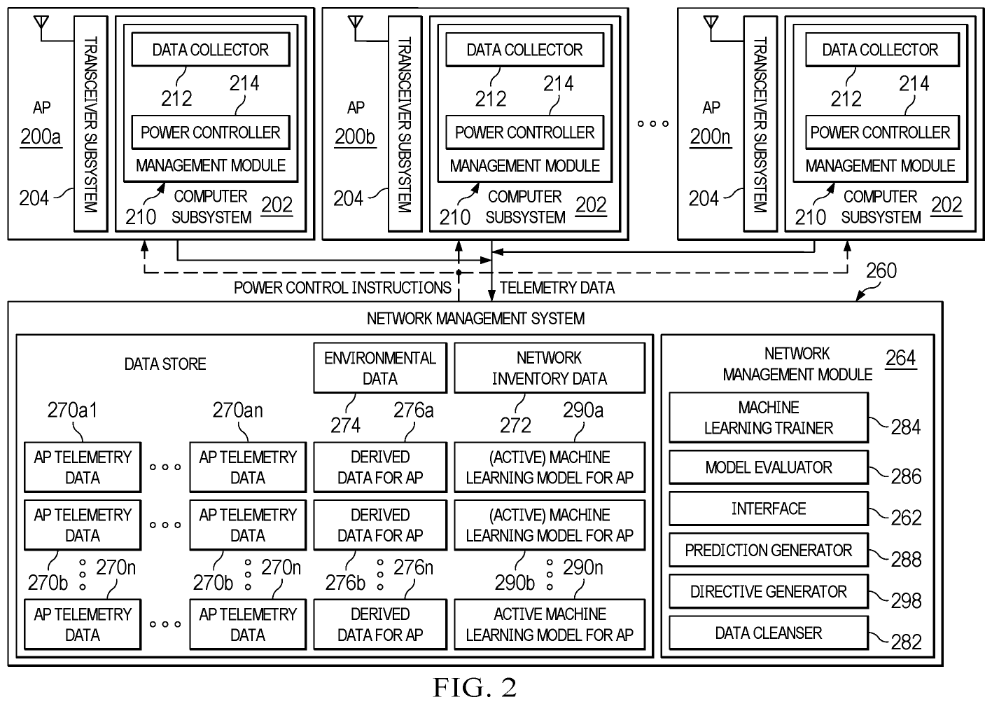

Moving now to FIG. 2, one embodiment of entities in a managed network, including one or more APs 200 (e.g., 200a-200n) and network management system 260, is depicted. Network management system 260 may include one or more computing devices or applications that may be deployed in the same (or different) network, or which may be distributed or deployed in a distributed computing infrastructure such as a cloud based computing environment or the like. APs 200 (e.g., 200a, 200b, 200n) can comprise computer subsystem 202 and transceiver subsystem 204 coupled to an antenna. Computer subsystem 202 can include one or more processors, a data subsystem, and a network interface. These processors can be in communication with transceiver subsystem 204 to configure the transceiver subsystem 204 and otherwise control operations of the transceiver subsystem 204. The network interface can serve as an interface for communicating data between AP 200 and other computer systems or networks.

Transceiver subsystem 204 can include a power amplifier, a radio component, logic for implementing certain communication standards (e.g., IEEE 802.11), and memory. Power amplifier can provide power to the radio, for example, in order to transmit and receive signals via the antenna. This logic can comprise data processing elements such as an ASIC (application specific integrated circuit), FPGA (field programmable array), digital processing unit, and the like. Logic 248 can be configured to process signals received, or signals for transmission (e.g., in accordance with IEEE 802.11).

The data subsystem of computer subsystem can include storage or memory (used herein interchangeably to include an medium that can be utilized for storing data) such as a random access memory (RAM) for storage of instructions and data during program execution, read only memory (ROM) in which fixed instructions are stored, or other persistent (i.e., non-volatile) or non-persistent storage for program and data files. This storage may include program code or data, which when executed by computer subsystem 202, can cause processors to perform operations in accordance with embodiments as discussed.

Specifically, an AP management module 210 may be executing on AP 200, where the management module 210 may include a data collector 212 and a power controller 214. Data collector 212 may operate to collect data associated with AP 200 and send collected telemetry data from the AP 200 to network management system 260. Power controller 214 may be adapted to receive power control instructions from network management system 260 to change an operational state of the AP 200. Such power control instructions can, for example, scale (e.g., reduce or turn off) certain functionality on the AP 200 (e.g., power the AP down, provide fewer functions, less capacity, etc.).

In some embodiments, data collector 212 may be configured to access a particular location (e.g., a Uniform Resource Locator (URL)) associated with an interface 262 of network management module 264 on network management system 260 to send telemetry data from the AP 200 to that location. This telemetry data can, for example, be in almost any format desired. For example, in one embodiment this telemetry data may be sent in as a set of comma separated values (CSV). This telemetry data can thus be sent and received at regular intervals (e.g., every 10 seconds, every minute, every hour, etc.) and stored at network management system 260 in association with that AP 200 by the network management module 260. Thus, AP telemetry data 270 may be stored for each AP 200 within the network, where multiple instances of telemetry data 270 may be stored for a particular AP 200, each instance of AP telemetry data 270 associated with a particular time period (e.g., telemetry data 270a may correspond to AP 200a, where each instance of telemetry data 270a1, 270an may corresponding to a different time period (or be reported from AP 270a at a different time).

Specifically, this telemetry data 270 (e.g., for a time period) may include timestamped data for the AP 200, denoting a number of clients that are associated with the AP 200 in that time period and are deemed “active.” In some embodiments, a client can be deemed active based on the number of data units (bytes, packets, etc.) exchanged with that AP 200 during a period of time. The telemetry data 200 may also include a number of connected clients per radio. As some APs 200 can be configured with multiple radios (e.g., 2.4 GHz radio, 5 GHz radio, etc.), the telemetry data 270 can refer to the number of clients that are active on a given radio. Data on each connected client can also be included in the telemetry data 270 such as device identifiers, number of packets received or sent to the client, or other client specific information.

Other telemetry data 270 collected by data collector 212 and reported to network management system 260 may include buffer occupancy which may pertain to the average size of all the data queues at the AP 200 used to buffer uplink and downlink packets. The telemetry data 270 may include Ethernet link utilization associated with (e.g., average) values of the uplink and downlink utilization of a given Ethernet link or self-channel utilization associated with the utilization of a channel (transmit and receive activity) for a given period of time during which the radio occupied the channel to transmit and receive signals. Each radio in the AP 200 may be associated with a self-channel utilization metric. Such telemetry data 270 may also include configuration settings such as active (or inactive) features on the AP 200, as some protocol or software features utilized by the AP 200 can result in increased consumption of power when enabled. Certain of the telemetry data 270 may also include data on physical operating parameters pertaining to the AP 200 such as temperature data.

As but one example, APs 200 may periodically (every 60 seconds) send data in CSV to include client information, radio information and device information in the following formats:
<epoch_timestamp>,<client: mac>, <client: in-pkts>, <client: out-pkts>, . . .

At time: 1705400059

| | | | |
|---|---|---|---|
| 1705400059 | 001B638445E6 | 256 | 1024 |
| 1705400059 | 001B638445E8 | 2046 | 255 |
| 1705400059 | 001B638445E9 | 3096 | 64 |

<epoch_timestamp>, <radio:band>,<radio:channel_width>,
<radio:bandwidth>, <radio:tx_power>, . . .

At time: 1705400059

| | | | | |
|---|---|---|---|---|
| 1705400059 | 2.4G | 20 | 1024 | 18 |
| 1705400059 | 5G | 80 | 255 | 19 |
| 1705400059 | 6G | 320 | 64 | 15 |

<epoch_timestamp>, <memory: total>, <memory: available>,<memory: utilized>, . . .

At time: 1705400060

| | | | |
|---|---|---|---|
| 1705400060 | 2048 | 1096 | 952 |

Network management module 264 may also collect other data (collectively referred to as network inventory data 272) associated with the network including APs 200 (or other data regarding APs 200 within the network). Such data can include a static list of devices (e.g., Internet of Things (IOT) devices) that may be coupled to each AP 200 and physical configurations of the APs 200 such as the model numbers or information on types of antennae equipped on an AP 200. This type of data may be obtained, for example, from an inventory database or the like that may be created or maintained by designers or providers of a network or manually input through interface 262 of network management module 264.

Environmental data 274 may also be determined and collected by network management module 264 based on sensors deployed in the physical environment in which the network including APs 200 exists. This environmental data 274 may include the physical layout (e.g., floorplans) of the environment in which the network is installed or the location of APs 200 within that physical environment or other data on the physical environment in which the network operates such as movement data corresponding to the movement of users (e.g., clients) within the physical environment.

In some embodiments, this various data may be collected (e.g., at regular intervals) by network management module 264 for an initial time period (e.g., a week, a month, etc.). The collected data on the APs 200 in the network can then be cleansed and augmented by data cleanser 282. Data used to augment collected telemetry data 270 may include data derived from a single instance of telemetry data 270 (e.g., 270a1) from an AP 200 (e.g., AP 200a) or derived from data in two or more instances of telemetry data 270 (e.g., 270a1, 270an) received from the AP 270 (e.g., 270a). Thus, derived data 276 (e.g., where there may be derived data 276a, 276b, 276n associated with each AP 200a, 200b, 200n) may be data that can be determined based on telemetry data 270 provided to the network management module 264 by the APs 200 (e.g., either the same or different APs 200). For example, the type of devices that are connected to an AP 200 at a given time may be derived using device profiling based on the information about these devices (e.g., the IP or MAC address of the device) sent from the AP 200 in telemetry data 270 provided by that AP 200.

The derived data 276 may also include authentication or accounting data that may be determined from authentication, authorization, and accounting (AAA) servers such as those using the Remote Authentication Dial-In User Service (RADIUS) protocol. Derived data 276 may also include determining devices (clients) which are constantly connected to an AP 200 by comparing connected clients across data sets to determine which clients are substantially always connected to that AP and do not move or disconnect.

The cleansing of data by data cleanser 282 may involve removing data points for a label (e.g., parameter or metric) that are outside a certain range of values for that parameter. For example, data points may be removed that are outside a standard deviation of the range of values for those points. In some embodiments, this cleansing may occur on each set of telemetry data 270 provided by an AP 200 and the range of values for a parameter that are used to determine standard deviations for cleansing of that data may be based on the range of values in that set of telemetry data 270 as received from that AP 200. Thus, when network management module 264 receives telemetry data 270 from an AP 200 it can determine the range of values for each parameter included in that telemetry data 270 (e.g., the difference between values at either extreme of the parameter, such as high and low values). When a value for a parameter is subsequently discovered that is outside the range of values for that parameter, that value may be removed by data cleanser 282, or that value may be set to a maximum high value (when the maximum high value is exceeded) or a minimum low value (when the value is below the minimum low value) determined for that parameter from that instance of telemetry data 270. In particular, according to certain embodiments, those maximum high values and minimum low values may also be determined based on the range of values for that parameter in that particular set of telemetry data 270 as received from the AP 200.

Data associated with APs 200 (e.g., telemetry data 270, environmental data 274, network inventory data 272, etc.) may be utilized by machine learning trainer 284 to train machine learning models 290 for prediction of power control of those APs 200. In particular, in some embodiments machine learning trainer 284 may be adapted to train a machine learning model 290 (e.g., 290a, 290b, 290n) for prediction of power control for each specific AP 200 (e.g., 200a, 200b, 200n) based on telemetry data 270 for that specific AP 200 (e.g., 270a, 270b, 270n). Machine learning models 290 may be adapted to make predictions based on historical observation. Thus, machine learning trainer 284 may determine training data comprising a set of labeled data (e.g., the metrics or parameters included in the telemetry data 270, derived data for the AP 276, environmental data 274, or network inventory data 272) and use this training data to train (or re-train) machine learning model 290. This machine learning model 290 is thus adapted to make power control predictions by mapping an input space to labels in a discrete label set. In other words, a prediction or classification for a label can be generated based on a set of labeled input values using the trained machine learning model 290.

In certain embodiments, machine learning trainer 284 may train machine learning model 290 for classification for a particular AP 200 using time-series data in a training set derived based on AP telemetry data 270 from that AP 200. There are various model training frameworks that can be used (e.g., TENSORFLOW by Google, PyTorch, and MXNet). Further there are many ML algorithms (e.g., K-Means, Logistic Regression, Support Vector Machines, Bayesian Algorithms, Perceptron, Convolutional Neural Networks, Recurrent Neural Networks such as Long Short-Term Memory, Random Forest, Isolation Forest) that may be employed according to embodiments.

Machine learning trainer 284 may be configured to utilize one or more training triggers such that when a training trigger is detected, a determination of a (e.g., new) set of training data may be made and the (re) training of machine learning model 290 for AP 200 may be initiated. Training triggers may be based on, for example, an amount of training data received from an AP, quality metrics determined for an active machine learning model, elapsed time, or other criteria. Thus, it will be noted that the training of different machine learning models 290 for different APs 200 may (or may not) take place asynchronously, and each training of the machine learning model 290 may utilize different sets of training data.

In one embodiment, machine learning trainer 284 may train multiple machine learning models for an AP 200 based on (e.g., cleansed and augmented) training data. For example, there may be a trained machine learning model 290 corresponding to each of the APs 200 within a network, where that machine learning model 290 was trained based on corresponding training data derived from data (e.g., telemetry data 270) associated with that particular AP. Each of the trained models may be adapted to provide a prediction for one or more labels for the corresponding AP (e.g., values for a label of interest for that AP based on a set of values for one or more input labels). In one embodiment, for example, the trained model may be configured to provide a prediction for a label associated with a number of clients for the corresponding AP (or a binary value predicting whether any clients will be connected to that AP) based on, for example, a provided time or other provided input values for label data. Such a prediction may further comprise a number of clients that may be coupled to different radios (e.g., different frequency radios) of the AP during the time period when the AP is configured with multiple radios.

Trained machine learning models 290 for an AP 200 may be evaluated by model evaluator 286. For example, when a machine learning model 290 for power control of a corresponding AP 200 is trained it may be evaluated for a period of time, where predictions (e.g., values for a label such as number of connected clients for a time or time period) generated by the trained machine learning model 290 for an AP 200 are evaluated against data sets obtained from that AP 200 to determine a quality metric associated with the trained model for that AP 200. These actual data sets may be data sets from the AP that are different from the telemetry data 270 obtained from the AP 200 that were used to determine training data used to train that machine learning model 290.

For example, model evaluator 286 may use trained machine learning model 290 for an AP 200 to generate predictions for a future time period for that AP 200 and those generated predictions compared against actual data (e.g., telemetry data 270) obtained from the AP 200 after that future time period has passed. Quality metrics known in the art such as accuracy, precision or recall may be utilized by model evaluator 286 to evaluate the trained machine learning model 290 such that model evaluator 286 can determine when a desired efficacy of the trained machine learning model 290 is achieved. If a desired threshold for the quality metric is not met the machine learning model 290 may be additionally trained (e.g., on a different or additional set of training data) by machine learning trainer 284. Once a desired threshold for the quality metric is met for the model (e.g., a 95 percent accuracy with respect to comparison of predicted values for a time period to actual values for that time period), model evaluator 286 can determine the machine learning model 290 may be utilized for power control of the AP 200 (e.g., made an active machine learning model), otherwise additional training may be undertaken on the machine learning model 290 by machine learning trainer 284.

In some embodiments, multiple (e.g., challenger) machine learning models for a particular corresponding AP may be trained by machine learning trainer 284 and evaluated by model evaluator 286, where these trained machine learning models may be different types of machine learning models. These multiple trained challenger machine learning models for an AP 200 can then be evaluated against each other (e.g., or a current active machine learning model 290 for the AP 200) to determine which machine learning model (or models) trained for that AP 200 should be selected as a current active machine learning model 290 for generating predictions for that AP 200 (e.g., responses to labeling requests). This evaluation can be based, for example, on a quality metric determined for each of the challenger machine learning models. The result of this evaluation may be a selected champion machine learning model that represents the best model currently producible given the available training data (e.g., as determined from a quality metric associated with each of the machine learning models). This champion machine learning model can thus be used as an active machine learning model 290 for generating predictions (e.g., values for labels in response to labeling requests).

Once an (active) machine learning model 290 is determined (e.g., a quality metric for a trained machine learning model is determined to be above some threshold or a best machine learning model is selected from a set of challenger machine learning models), that machine learning model 290 can be utilized by prediction generator 288 to generate predictions associated with power control of the AP 200 in the network corresponding to that machine learning model 290. In other words, values for certain labels may be generated using the active machine learning model 290 for the AP 200, where those values are predictive of values for that label based on one or more input label values. These power control predictions may be generated based on certain time periods (e.g., seconds, hours, days, weeks, etc.) for future time periods (e.g., the time period may serve as a labeled input value). In one embodiment, for example, predictions may be generated for a number of clients that will be connected to the corresponding AP 200 for a number of times or time periods.

The power control predictions generated for an AP 200 by prediction generator 288 using machine learning model 290 corresponding to that AP 200 can then be used by directive generator 298 to determine a power control directive for that AP 200, where the power control directive is associated with certain functionality of the AP 200. Specifically, a generated power control directive may be associated with a functionality of the AP 200 and may specify a set of functionality or a power level associated with that functionality. For example, a predicted number of clients for a (e.g., future) time period generated as a power control prediction may be used to determine whether to power on or power off the AP 200 or certain functionality during that (future) time period. Accordingly, a binary decision can be made to power on or power off the AP or certain functionality of the AP 200 based on if the power control prediction indicates one or more clients are predicted to be connected to that AP 200 during that time period. As another example, a predicted number of clients generated by the prediction generator 288 for the time period may be used to determine a power level for certain functionality of the AP 200 (e.g., high, medium, low, off) based on a threshold number of clients associated with each of these power levels.

Based on this determined power control directive for the AP 200, directive generator 298 may determine one or more power control instructions for the AP 200. These power control instructions may be sent through interface 262 to AP management module 210 on the AP 200 to control the AP 200 during the corresponding time period associated with the power control directive. Power controller 214 on the AP 200 can effectuate the power control instructions on the AP 200 to change an operational state of the AP 200 in accordance with the power control directive. Such power control instructions can, for example, scale (e.g., reduce or turn off) certain functionality on the AP (e.g., power the AP down, provide fewer functions, less capacity, etc.).

Alternatively, the power control directive (or predictions generated by the machine learning model or power control instructions) may be presented as a set of recommendations for the AP 200 for the corresponding time period to a user (e.g., of network management system 260). For example, the power control directive may be presented through a network management interface 262 in association with an identifier for the AP 200 and the time period corresponding to the power control directive.

Various operational aspects of the AP 200 can thus be controlled to change the power consumed by the AP, whether to decrease power consumption or increase power consumption to resume full-function operation. This functionality can be controlled (e.g., functionality increased, decreased, turned ON, turned OFF, etc.) to change the power consumption of the AP in response to power control instructions. For example, one or more radios in the AP can be placed in the on or off state to reduce power consumption. Accordingly, if the AP is configured with multiple radios a power control instruction may be to turn off some but not all radios. Universal Serial Bus (USB) capabilities can also be placed in an on (enabled) or off (disabled state). The Bluetooth capability of an AP may also be placed in Bluetooth Low Energy mode. The TX or RX chains of the AP may also be controlled. To illustrate, each radio in an AP can have multiple (2, 4, 8, etc.) independent transmit/receive chains. The chains allows the AP to multiplex a signal across two or more chains, for example, to achieve higher throughput, to reduce errors, etc. These TX or RX chains on the AP can thus be adjusted to alter the power consumed by the radio on the AP (e.g., more chains require more power, fewer chains require less power). Similarly, transmit power for each radio of the AP can be adjusted to change the AP's power consumption while maintaining a desired level of coverage. In some embodiments, the power can be adjusted between a maximum transmit power level (Pmax) and a minimum transmit power (Pmin). Likewise, channel bandwidth of these radios may also be controlled. Specifically, the usage of different bandwidths affect power consumption of the AP differently-more bandwidth requires more power. Thus, the radios of an AP can be adjusted to transmit in narrower bandwidths to reduce power consumption. For instance, bandwidths to control can be selected from 320/160/80/40/20 MHz. Protocol or software functionality of the AP may also be controlled to reduce power consumption. Specifically, certain protocols or software features can impact how much power is consumed by the AP. These features can be disabled to reduce power consumption. For example, scanning of the RF environment is a feature that can be turned off to reduce power. Other features can also be tuned or adjusted to control or otherwise influence power consumption of an AP.

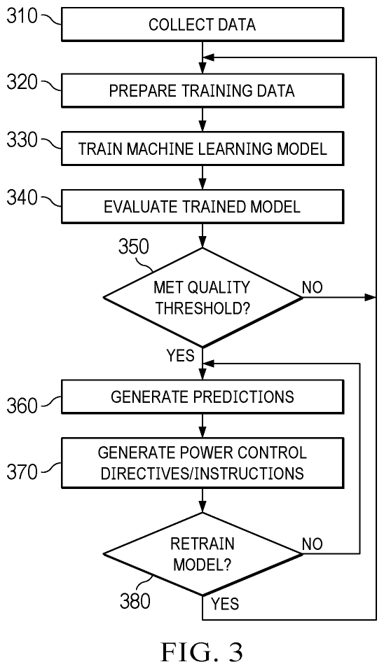

FIG. 3 depicts one embodiment of a method for managing a network using proactive power control of APs in the network. Initially, data associated with APs in a network may be collected or determined (STEP 310). This data may include telemetry data sent from the AP at regular intervals. Thus multiple instances of telemetry data may be received and stored for each of a set of APs in the network, where each instance of AP telemetry data for an AP is associated with a particular time period. For example, this telemetry data may include timestamped data specifying a number of clients that are associated with the AP in that time period. Data on each of these clients can also be included in the telemetry data such as device identifiers, number of packets received or sent to the client, or other client specific information. Other collected data associated with APs in the network can include a static list of devices that may be coupled to each AP and physical configurations of the APs. Environmental data may also be determined and collected based on sensors deployed in the physical environment in which the network is implemented.

A set of training data can then be prepared for each of the APs based on this collected data (STEP 320). Each set of training data may thus comprise a set of labeled data associated with a particular AP of the set of APs. As part of the preparation of the training data the collected data can be cleansed or augmented. The augmented data may thus include data derived from a single instance of telemetry data for that AP or derived from data in two or more instances of telemetry data received from that AP. The augmented data may also include authentication or accounting data that may be determined from AAA servers or devices (clients) which are connected to that AP. The cleansing of the collected data may comprise removing data points for a label that are outside a certain range of values for that parameter.

The set of training data for each AP may then be utilized to train a machine learning model adapted for predictive power control of that corresponding AP (STEP 330). The trained machine learning models can thus be adapted to make predictions for the corresponding AP based on historical observations associated with that AP. Specifically, the trained machine learning model may be adapted to map an input space to labels in a discrete label set to generate a prediction or classification for a label. In one embodiment, multiple machine learning models may be trained for a (e.g., single) AP where each of those multiple machine learning models may be adapted to provide a prediction for one or more labels for the corresponding AP (e.g., there may be different machine learning models for an AP where those different machine learning models may correspond to different, or the same, labels).

The trained machine learning models for each AP may then be evaluated (STEP 340). In some embodiments, this evaluation may include using a trained machine learning model to generate predictions for power control of a corresponding AP for a future time period and comparing the generated predictions to actual data associated with that time period and the corresponding AP when such data becomes available. This comparison can be utilized to generate a quality metric associated with the trained model such as a measurement of accuracy, precision or recall for the trained machine learning model. This quality metric can then be evaluated against a threshold to determine if a desired threshold has been met (STEP 350).

If a desired threshold for the quality metric is not met (N Branch of STEP 350) the machine learning model may be additionally (re) trained (e.g., on a different or additional set of training data) (STEPS 320, 330). Once a desired threshold for the quality metric is met for the model (Y Branch of STEP 350), the machine learning model may be utilized for power control of the corresponding AP. Accordingly, that machine learning model can be utilized to generate predictions associated with power control of the corresponding AP (STEP 360). These predictions may comprise values for certain labels generated using the machine learning model, where those values are predictive of values for that label for the corresponding AP. These power control predictions may be generated based on certain time periods (e.g., seconds, hours, days, weeks, etc.) for future time periods (e.g., the time period may serve as a labeled input value). In one embodiment, for example, predictions may be generated for a number of clients that will be connected to the corresponding AP for a time period.

The power control predictions generated for an AP using the machine learning model can then be used to determine a power control directive or power control instructions for that AP (STEP 370), where the power control directive is associated with certain functionality of the AP. Specifically, a power control directive may be associated with a functionality of the AP and may specify a set of functionality or a power level associated with that functionality. For example, a predicted number of clients for a (e.g., future) time period generated as a power control prediction may be used to determine whether to power on or power off the AP or certain functionality during that (future) time period Based on this determined power control directive for the AP, one or more power control instructions for the AP may be determined. These power control instructions may be sent to the AP to control the AP during the corresponding time period associated with the power control directive. Such power control instructions can, for example, scale (e.g., reduce or turn off) certain functionality on the AP (e.g., power the AP down, provide fewer functions, less capacity, etc.). Alternatively, the power control directive (or predictions generated by the machine learning model or power control instructions) may be presented as a set of recommendations for the AP for the corresponding time period to a user.

At some point it can be determined if a retraining of the machine learning model should occur (STEP 380). For example, one or more training triggers may be evaluated such that when a training trigger is detected, a (re) training of a machine learning model for an AP may be initiated. Training triggers may be based on, for example, an amount of training data received from an AP, quality metrics determined for an active machine learning model, elapsed time, or other criteria. When it is determined that retraining of the model should be initiated (Y Branch of STEP 380) the machine learning model may be additionally (re) trained (e.g., on a different or additional set of training data) (STEPS 320, 330), otherwise the model may continue to be used to generate predictions for the AP (N Branch of STEP 380).

It will be understood that while specific embodiments have been presented herein, these embodiments are merely illustrative, and not restrictive. Rather, the description is intended to describe illustrative embodiments, features and functions in order to provide an understanding of the embodiments without limiting the disclosure to any particularly described embodiment, feature, or function, including any such embodiment, feature, or function described. While specific embodiments of, and examples for, the embodiments are described herein for illustrative purposes only, various equivalent modifications are possible within the spirit and scope of the invention, as those skilled in the relevant art will recognize and appreciate.

As indicated, these modifications may be made in light of the foregoing description of illustrated embodiments and are to be included within the spirit and scope of the disclosure. Thus, while particular embodiments are described, a latitude of modification, various changes and substitutions are intended in the foregoing disclosures, and it will be appreciated that in some instances some features of embodiments of the invention will be employed without a corresponding use of other features, and features described with respect to one embodiment may be combined with features of other embodiments without departing from the scope and spirit of the disclosure as set forth.

What is claimed is:

1. A method for adjusting power consumption in an access point (AP) in a network using machine learning, comprising:
receiving a first set of telemetry data from an AP in a wireless network, the telemetry data associated with operation of the AP in the wireless network;
applying a transformation to the first set of telemetry data to create modified first telemetry data associated with the AP, including augmenting the first set of telemetry data with data derived based on the first set of telemetry data;
creating a first training set associated with the AP from the first set of telemetry data and modified first telemetry data;
training, at a first time using the first training set, a machine learning model corresponding to the AP, wherein the machine learning model is adapted to generate a power control prediction for the AP, the power control prediction associated with a time period;
generating a first power control prediction for a first time period for the corresponding AP using the machine learning model; and
determining a power control directive for the corresponding AP for the first time period based on the first power control prediction, wherein the power control directive specifies an operational state of a functionality of the AP for the first time period.

2. The method of claim 1, further comprising determining a power control instruction for the AP based on the power control directive, the power control instruction adapted to configure, at the AP, the operational state of the functionality of the AP according to the power control directive and the first time period.

3. The method of claim 2, wherein the functionality is associated with at least one of a state of a radio of the AP, a Universal Serial Bus (USB) capability of the AP, a Bluetooth capability of the AP, a Transmit (TX) or a Receive (RX) chain of the AP or a protocol feature of the AP.

4. The method of claim 3, wherein the state of the radio comprises a transmit power of the radio or a channel bandwidth of the radio.

5. The method of claim 1, further comprising, presenting the power control directive in association with an identifier for the AP and the first time period through a network management interface.

6. The method of claim 1, wherein the power control prediction is associated with a number of active clients connected to the AP during the first time period.

7. The method of claim 1, further comprising:
evaluating the trained machine learning model using a second set of telemetry data associated with operation of the AP in the wireless network to determine a quality metric for the trained machine learning model;
when the quality metric is below a threshold:
determining a third set of telemetry data from the AP, the third set of telemetry data associated with operation of the AP in the wireless network;
creating a second training set associated with the AP from the third set of telemetry data; and
training, at a second time, the machine learning model corresponding to the AP using the second training set.

8. The method of claim 7, wherein training the machine learning model at the first time, comprises:
training multiple machine learning models based on the first training set associated with the AP;
evaluating the multiple machine learning models for the AP using the second set of telemetry data to determine the quality metric associated with each one of the multiple machine learning models; and
selecting the machine learning model from the multiple machine learning models based on the quality metric associated with each of the multiple machine learning models.

9. The method of claim 8, wherein the multiple machine learning models comprise at least two different types of machine learning models.

10. A system for adjusting power consumption in an access point (AP) in a network using machine learning, comprising:
a processor; and
a non-transitory computer readable medium comprising instructions for:
receiving a first set of telemetry data from one or more APs in a network, the telemetry data associated with operation of the APs in the network;
creating a first training set associated with the one or more APs from the first set of telemetry data;
training a machine learning model corresponding to the one or more APs, the machine learning model adapted to generate a power control prediction for a time period for the one or more APs;
generating a first power control prediction for a first time period for the one or more APs using the machine learning model; and
determining a first power control directive for the one or more APs for the first time period based on the first power control prediction, wherein the first power control directive specifies a first operational state of a first functionality of the one or more APs for the first time period.

11. The system of claim 10, wherein the instructions are further for: determining a second power control directive for the one or more APs for the first time period, wherein the second power control directive specifies a second operational state of a second functionality of the one or more APs for the first time period.

12. The system of claim 11, wherein the second power control directive is based on the first power control prediction.

13. The system of claim 12, wherein the instructions are further for: generating a second power control prediction for the first time period for the one or more APs using the machine learning model, and wherein the second power control directive is based on the second power control prediction.

14. The system of claim 10, wherein the instructions are further for: determining a second power control directive for the one or more APs for a second time period.

15. The system of claim 14, wherein the second power control directive specifies a second operational state of the first functionality of the one or more APs for the second time period or the second power control directive specifies a third operational state of a second functionality of the one or more AP for the second time period.

16. The system of claim 14, wherein the instructions are further for: generating a second power control prediction for the second time period for the one or more APs using the machine learning model and the second power control directive is based on the second power control prediction.

17. A non-transitory computer readable medium, comprising instructions for:
receiving a first set of telemetry data from an AP in a wireless network, the telemetry data associated with operation of the AP in the wireless network;
creating a first training set associated with the AP from the first set of telemetry data;
training, at a first time using the first training set, a machine learning model corresponding to the AP, wherein the machine learning model is adapted to generate a power control prediction for the AP, the power control prediction associated with a time period;
generating a first power control prediction for a first time period for the corresponding AP using the machine learning model; and
determining a power control directive for the corresponding AP for the first time period based on the first power control prediction, wherein the power control directive specifies an operational state of a functionality of the AP for the first time period.

18. The non-transitory computer readable medium of claim 17, wherein the first training set is created from environmental data or network inventory data associated with the wireless network.

19. The non-transitory computer readable medium of claim 17, wherein the first training set is created based on data associated with device types of clients connected to the AP.

20. The non-transitory computer readable medium of claim 17, wherein the instructions are further for:
evaluating the trained machine learning model using a second set of telemetry data associated with the AP to determine a quality metric for the trained machine learning model; and
retraining the machine learning model when the quality metric is below a threshold.
